(19) United States
(12) Patent Application Publication
(10) Pub. No.: US 2003/0196532 A1
(43) Pub. Date: Oct. 23, 2003

(54) Adjustable guide for rotary saw

(76) Inventor: Wallis L. Alsruhe, Manchester, MD (US)

Correspondence Address: SHOOK, HARDY & BACON, 1200 MAIN STREET, ONE KANSAS CITY PLACE, KANSAS CITY,, MO, 64105-2118, US

(21) Appl. No.: 10/222,139

(22) Filed: Aug. 16, 2002

Related U.S. Application Data
(63) Continuation-in-part of application No. 10/125,110, filed on Apr. 18, 2002.

(51) Int. Cl. B26D 7/06; B23D 21/14; B26D 1/56; B23D 25/02

(52) U.S. Cl. 83/187; 83/331; 83/115

(57) ABSTRACT

A rotary saw having an adjustable depth guide with a handle portion attached thereto is provided. The rotary saw has a housing with a flange projecting outwardly therefrom. The depth guide includes a column with a vertical channel therein. The depth guide is coupled with the housing by slidably receiving the flange in the channel. A transverse bolt in the housing permits a user to prevent movement between the depth guide and the housing and thereby set a cutting depth. A handle portion is removably coupled with the depth guide such that movement between the depth guide and the housing does not alter the relationship between the depth guide and the handle portion.

### CROSS-REFERENCE TO RELATED APPLICATIONS

The present application is a continuation-in-part of application Ser. No. 10/125,110, filed Apr. 18, 2002, of the same title and by the same inventor.

### STATEMENT REGARDING FEDERALLY SPONSORED RESEARCH OR DEVELOPMENT

Not Applicable.

### BACKGROUND OF THE INVENTION

The present invention relates to a rotary saw. More particularly, this invention relates to an improved depth guide for use in connection with a rotary saw.

In recent years, the availability and popularity of rotary saws have increased dramatically. As word of the versatility afforded by rotary saws spreads, more and more people have begun to use these compact saws in connection with their ordinary tasks.

Rotary saws generally include a tubular housing which contains a motor therein. The housing is generally of an outer diameter small enough to permit a user to grasp the housing during operation of the saw. The motor drives a collet which removably retains a spiral cutting saw bit. The bit rotates about its own axis similar to a drill bit. Unlike a drill bit, however, the spiral cutting saw bit has a spiral cutting edge that permits the bit to cut along its side when the tool is moved laterally. The tool is arranged such that the longitudinal axis of the bit is co-axial with a central longitudinal axis of the tool's housing.

Rotary saws are generally equipped with a depth guide of some sort that permits the user to vary the depth the rotary saw cuts in a workpiece during use. Depth guides generally take the shape of an annular ring which is mechanically spaced apart from the housing of the rotary saw in some adjustable manner. The spiral cutting bit in turn extends through the center of the annular ring. The greater the amount of the bit that extends through the ring, the greater the cutting depth of the rotary saw.

Depth guides of the prior art generally include a flat or arcuate metal tongue which extends downwardly from the housing and a corresponding flat or arcuate metal tongue which extends upwardly from the annular ring. The two tongues are overlapped in some fashion and secured together by a bolt passing through the tongues in a transverse orientation. The tongue that depends downwardly from the housing generally includes an internally threaded bore, while the tongue that extends upwardly from the annular ring generally includes a vertical slot. The slot permits the depth guide to slide toward and away from the housing, while the bolt permits the user to tighten the two tongues together when a desired cutting depth is achieved. This arrangement does not provide for a very structurally sound or stable depth guide.

While a rotary saw can be used by the user grasping the housing in their hand, it has been found beneficial in many instances to provide a handle which can be removably attached to the rotary saw. Handles of the prior art, however, have been attached directly to the housing of the rotary saw. Accordingly, as the depth of cut of the rotary saw is altered, so to is the distance the user's hand is located away from the work surface during use of the saw. It has been found that the stability of a rotary saw and a user's ability to control the rotary saw increase as the user's hand is moved toward the workpiece.

Accordingly, there is a need for a rotary saw with an improved depth guide and an improved handle. The present invention fills these and other needs.

### BRIEF SUMMARY OF THE INVENTION

In order to overcome the above-stated problems and limitations, and to achieve the noted objects, there is provided a rotary saw with a more substantial depth guide and a redesigned handle.

In general, the rotary saw includes a housing having a vertical flange extending outwardly from a surface thereof. A depth guide is provided having a column with a vertical channel therein which is slidably received on the flange of the housing. A bolt in the housing permits a user to “clamp” the column to the housing to set the depth of cut as desired.

A handle portion is preferably removably coupled with the column of the depth guide. Because the handle portion is connected to the depth guide, as opposed to being connected directly to the housing like the handles of the prior art, the relationship between the handle and the depth guide is not effected by adjusting the relationship between the depth guide and the housing. Accordingly, the handle portion remains the same distance away from a workpiece whether the depth of cut is large or small.

### BRIEF DESCRIPTION OF THE SEVERAL VIEWS OF THE DRAWING

The objects and features of the invention noted above are explained in more detail with reference to the drawing, in which like reference numerals denote like elements, and in which:

FIG. 1 is a perspective view of a first embodiment of a rotary saw having an adjustable depth guide of the present invention;

FIG. 2 is a side elevational view of the rotary saw of FIG. 1;

FIG. 3 is a cross-sectional view of the adjustable depth guide and the handle portion of the present invention taken generally along line 3-3 of FIG. 2;

FIG. 4 is an exploded perspective view of the rotary saw of FIG. 1;

FIG. 5 is a perspective view of a second embodiment of a rotary saw of the present invention with a portion of the handle portion cut away for clarity;

FIG. 6 is an exploded perspective view of the rotary saw of FIG. 5;

FIG. 7 is a rear perspective view of the depth guide of the second embodiment;

FIG. 8 is a bottom perspective view of a depth guide of a third embodiment of the present invention; and

FIG. 9 is a perspective view of a housing of the third embodiment of the present invention, with the handle portion, locking bolt and washer removed for clarity.

### DETAILED DESCRIPTION OF THE INVENTION

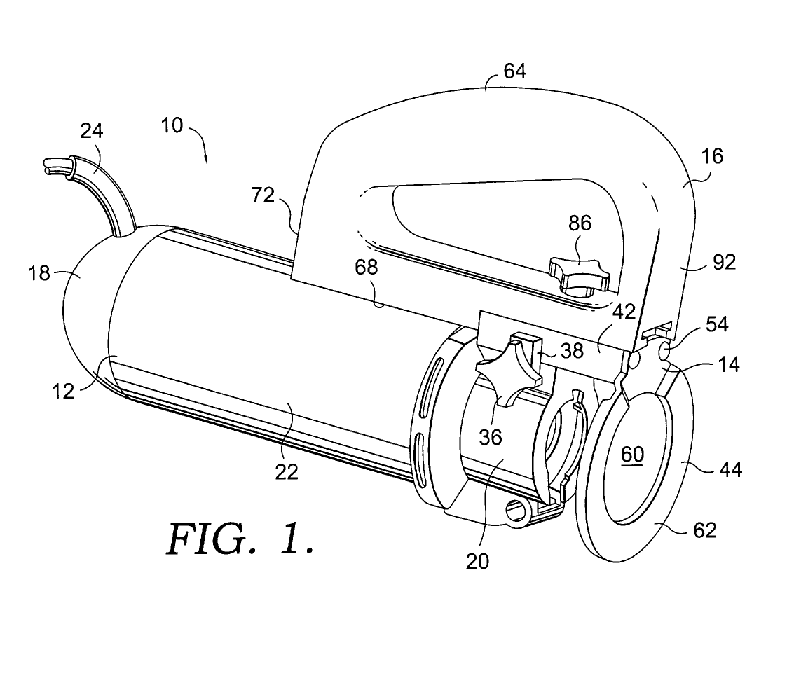

Referring now to the drawing in detail, and initially to FIG. 1, numeral 10 generally designates a first embodiment of a rotary saw of the present invention. The rotary saw 10 has a housing 12, an adjustable depth guide 14 and a handle portion 16.

The housing 12 is generally tubular in shape and has a top 18, a bottom 20 and an outer surface 22. The circumference of the outer surface 22 is preferably small enough to permit a user to grasp the housing in their hand during use of the saw 10. Accordingly, the circumference is preferably less than 11 inches and more preferably less than 9.5 inches. The housing 12 is generally made of plastic, although, as readily understood in the industry, the housing could be made of a variety of materials, including metal. Similarly, the housing may be formed of two pieces which mate in a clamshell fashion, as known in the art. The housing 12 defines an interior cavity (not shown) for enclosing a motor (not shown) for providing rotational output for the rotary saw 10. The motor preferably has an output of less than 700 watts and more preferably less than 400 watts. While the motor may be variable speed, the motor preferably has a no-load rotational speed in the range of 30,000 to 35,000 RPM. Although a rotary saw may be cordless, FIG. 1 illustrates a cord 24 for providing the motor with electrical power. A switch (not shown) is preferably provided in the housing for activating the motor.

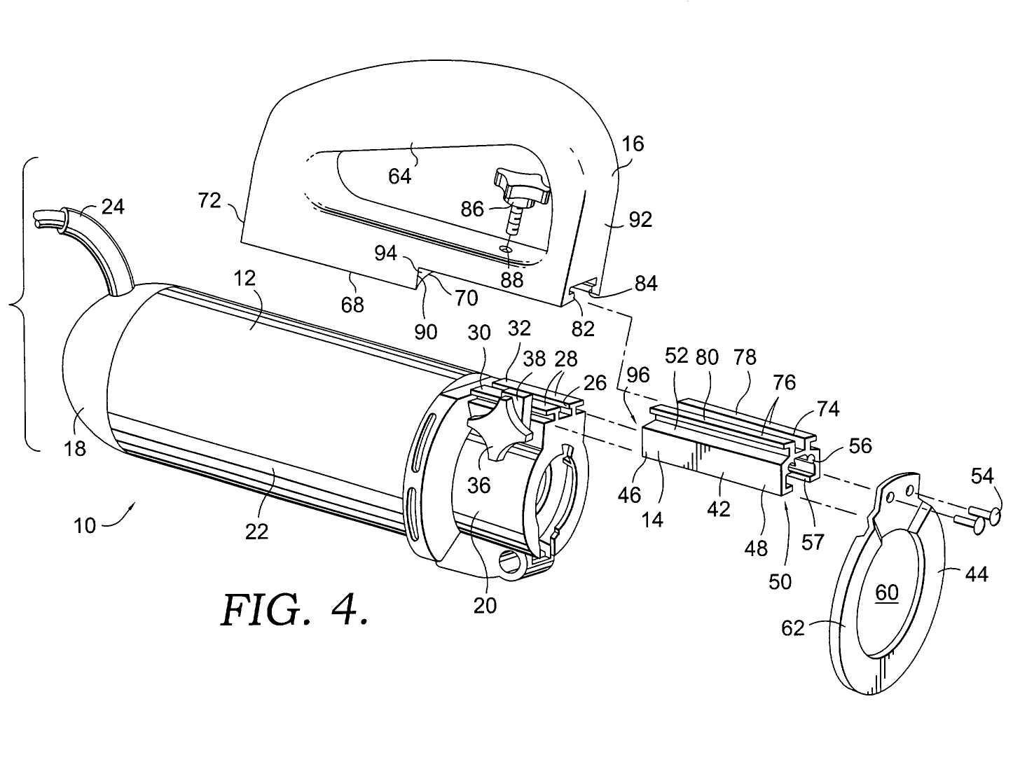

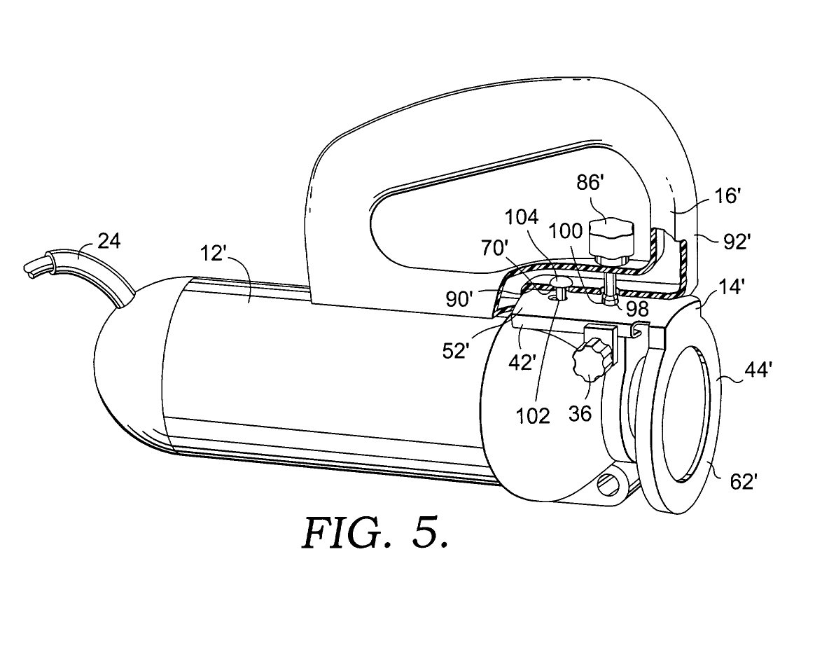

Adjacent the bottom 20 of the housing 12, and as best seen in FIG. 4, the housing 12 includes a first mating portion 26 which facilitates coupling of the depth guide 14 to the housing 12. The first mating portion 26 is generally a flange or rail 28 which projects outwardly from the outer surface 22 of the housing 12. The flange 28 has a longitudinal axis which is generally parallel to a central axis of the housing 12 about which a saw bit (not shown) of the rotary saw 10 rotates during use. In the first embodiment, the first mating portion 26 of the housing 12 preferably includes first and second flange members 30, 32. The flange members 30, 32 preferably have an T-shaped or L-shaped cross-section and are spaced apart in a back to back or mirror image relationship. It should be noted that while the flange 28 is illustrated in the first embodiment has having first and second flange members 30, 32 which cooperate to define the flange 28, it is well within the scope of the present invention for the flange 28 to have or be only one of the flange members 30, 32. Accordingly, the term “flange” can be used in the global sense to include several flange members or may be used in the specific sense to represent a single flange member.

The housing 12 also preferably includes a transverse bore 34 for receiving a locking bolt 36. A washer 38 and a locking nut 40 are received on the bolt 36 to permit a user of the rotary saw 10 to prevent movement of the depth guide 14 during use of the rotary saw 10, as discussed in greater detail below. The head of the locking bolt 36 is preferably configured to permit a user of the rotary saw to tighten or loosen the bolt 36 by using their fingers, as opposed to having to use a wrench.

The depth guide 14 preferably includes a column 42 and a guide base 44. The column 42 has an upper portion 46, a lower portion 48 and inner surface 50 and outer surface 52. The guide base 44 is preferably coupled with the lower portion 48 of the column 42 such that the guide base 44 lies in a plane generally perpendicular to a longitudinal axis of the column 42. It should be noted that, while the column 42 and guide base 44 are two separate pieces connected together by rivets 54 in the first embodiment of the depth guide 14 illustrated in FIGS. 1-4, it is well within the scope of the present invention to have a one piece depth guide as disclosed in a second embodiment of the depth guide illustrated in FIG. 5. To facilitate the manufacture of the column 42, the depth guide 14 of the first embodiment can be formed from extruded aluminum. The column 42 can even have eyelets 56 extruded therein to permit the guide base 44 to be removably attached to the column 42 by way of screws, as opposed to rivets 54.

The inner surface 50 of the column 42 includes a second mating portion 57 for cooperating with the first mating portion 26 to facilitate coupling of the depth guide 14 with the housing 12. The second mating portion 57 is generally a channel 58 in the inner surface 50 of the column 42. The channel 58 slidably receives the flange 28 of the housing 12 and facilitates coupling of the depth guide 14 to the housing 12.

The guide base 44 is generally shaped like a ring or a washer and includes a central opening 60 therein. A lower surface 62 of the guide base 44 abuts and slides across a workpiece during use of the rotary saw 10. The opening 60 permits a saw bit to extend therethrough and engage a workpiece during use.

When the flange 28 of the housing 12 is slidably received in the channel 58 of the column 42, a user of the rotary saw may selectively move the guide base 44 toward and away from the bottom 20 of the housing 12. By moving the guide base 44 toward and away from the bottom 20 of housing 12, a user can selectively adjust the amount of the saw bit which extends below the guide base and, hence, adjust the depth the rotary saw 10 cuts into a workpiece.

When the depth guide 14 is received on the housing 12, a portion of the column 42 is located between the washer 38 and the locking nut 40. Accordingly, when a user of the saw has positioned the guide base 44 a desired distance away from the bottom 20 of the housing 12, the user may lock the depth guide 14 in place, and thereby prevent movement between the depth guide 14 and the housing 12, by tightening the locking bolt 36. Tightening of the locking bolt 36 decreases the distance between the washer 38 and the locking nut 40 and pinches the column 42 between the washer 38 and the flange 28 of the housing 12, as best illustrated in FIG. 3. Once the user has securely tightened the locking bolt 36, the depth guide 14 cannot move with respect to the housing 12 and the user is free to use the saw without concern that the cutting depth will change during use. To adjust the depth of cut, the user simply then loosens or unscrews the locking bolt 36 to thereby permit the column 42 to freely slide up and down the outer surface 22 of the housing 12.

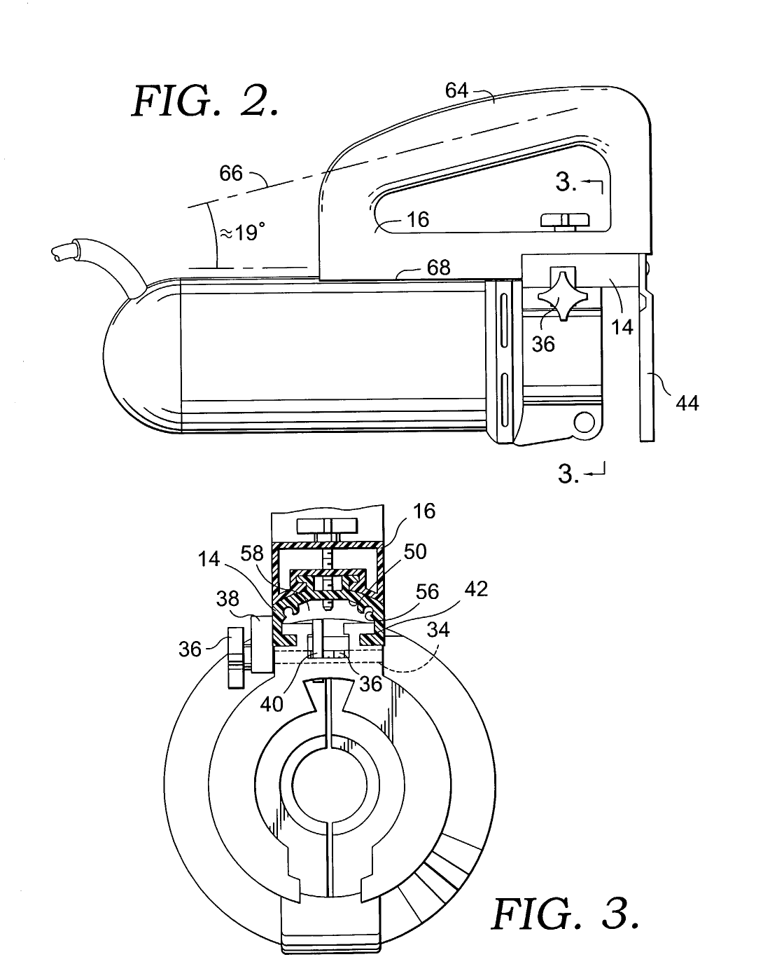

While a user of the rotary saw 10 may wish to use the rotary saw 10 without the handle portion 16 by simply grabbing the housing 12 during use, the presence of a handle has been found beneficial in many instances. Accordingly, the handle portion 16 preferably includes a gripping portion 64. The gripping portion 64 has a central longitudinal gripping axis 66. Because the shoulders of a user of the rotary saw 10 are almost always further away from the work surface during use of the rotary saw than the top of the housing is, the user's arm is almost always at an angle with respect to the workpiece during use of the rotary saw. Accordingly, it has been found beneficial to angle the gripping axis 66 of the handle portion 16 with respect to the workpiece. This angle can be expressed in terms of the relationship between the gripping axis 66 and the central longitudinal axis of the housing 12. While many different angles will work, preferably the angle is approximately 19°. Because an inner edge 68 of the handle portion 16 is generally parallel to the central longitudinal axis of the housing 12 when the handle portion 16 is coupled with the depth guide 14, the angle of the gripping axis with respect to the inner edge 68 would be the same and is illustrated as such in FIG. 2.

The handle portion 16 includes an inner surface 70. When the handle portion 16 is coupled with the depth guide 14, the inner surface 70 faces, and may even abut, the outer surface 22 of the housing 12. The inner surface 70 may also be formed to be convex from side to side such that the inner surface 70 is shaped to correspond with the outer surface 22 of the housing 12. Because the handle portion 16 is not directly connected to the housing 12, the concave mating arrangement helps retard lateral movement at a top 72 of the handle portion 16, yet still permits the handle portion 16 to freely move up and down the outer surface 22 of the housing 12 as the user adjusts the depth guide 14.

In the first embodiment of the present invention illustrated in FIGS. 1-4, the column 42 preferably includes a third mating portion 74. The third mating portion 74 is preferably a flange 76 on the outer surface 52 of the column 42. Preferably, the flange 76 is similar in structure to the flange 28 on the outer surface 22 of the housing 12. As with the flange 28 on the housing 12, the flange 76 on the column 42 preferably includes first and second flange members 78, 80 which run longitudinally along the column 42.

The handle portion 16 preferably includes a fourth mating portion 82. The fourth mating portion 82 preferably takes the shape of a channel 84 in the inner surface 70 of the handle portion 16. The channel 84 is constructed to slidably receive the first and second flange members 78, 80 of the column 42. This arrangement permits the handle portion 16 to be slid down onto the depth guide 14.

To prevent movement between the handle portion 16 and depth guide 14 during use, the handle portion is provided with a bolt 86 that is received in bore 88. While bore 88 could be internally threaded, such that the position of the handle member 16 relative to the depth guide 14 would be fixed by tightening the bolt 86 until it pressed against the outer surface 52 of the column 42 and frictionally engaged the flange 76 of the column 42 with the channel 84 of the handle member 16, an internally threaded opening (not shown) is preferably located in the outer surface 52 of the column 42 intermediate the first and second flange members 78, 80. Accordingly, as the bolt 86 is tightened, the handle portion 16 is drawn toward the column 42, instead of pushed away.

To assist with aligning the bore 88 in the handle portion 16 with the internally threaded bore in the column 42, the handle portion 16 is provided with a notch 90 adjacent a lower surface 92 of the handle portion 16. An upper surface 94 of the notch 90 abuts an upper surface 96 of the column 42 when the handle portion 16 is fully received on the depth guide 14. This arrangement not only aligns the bolt 86 in the handle portion 16 with the internally threaded bore in the column 42, but also puts the lower surface 92 of the handle portion 16 in a desired relationship with the lower surface 62 of the guide base 44. The notch 90 further prevents the lower surface 92 of the handle portion 16 from extending below the lower surface 62 of the guide base 44 during use and thereby altering the depth of cut even if the bolt 86 were to work loose.

It should be noted that by connecting the handle portion 16 directly to the depth guide 14, as opposed to the housing 12, the relationship between the lower surface 92 of the handle portion 16 and the guide base 44, as well as the relationship between the lower surface 92 of the handle portion 16 and the workpiece, does not change when a user changes the depth of cut. This arrangement provides that the lower surface 92 of the handle portion 16 continually resides close to or on the work surface of the workpiece during use to improve stability over handles of the prior art. Preferably the lower surface 92 is less than one half of an inch (½″) from the work surface. Additionally, since the handle portion 16 is attached to the depth guide 14, the closeness of the lower surface 92 of the handle portion 16 with respect to the workpiece is maintained regardless of adjustments to the depth guide or the cutting depth.

FIG. 5 illustrates a second embodiment of the present invention. Because the rotary saw of the second embodiment includes many of the same elements, the elements of the second embodiment will be referenced by the numerals given above in connection with the first embodiment. However, in the event that an element of the second embodiment is modified from the similar element in the first embodiment, the reference numeral will be followed by a prime mark.

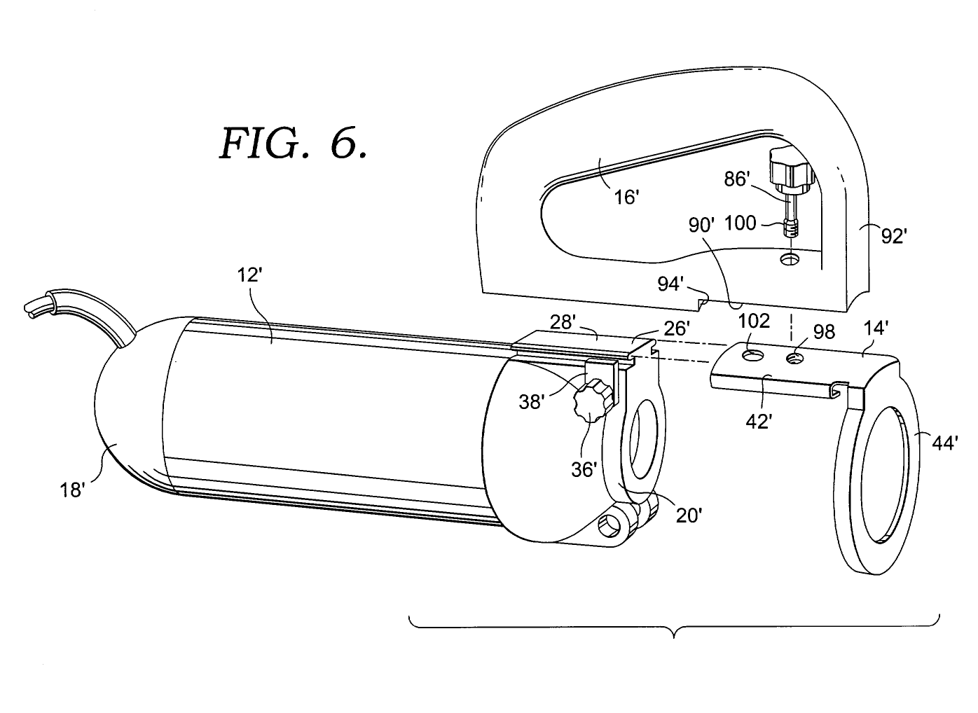

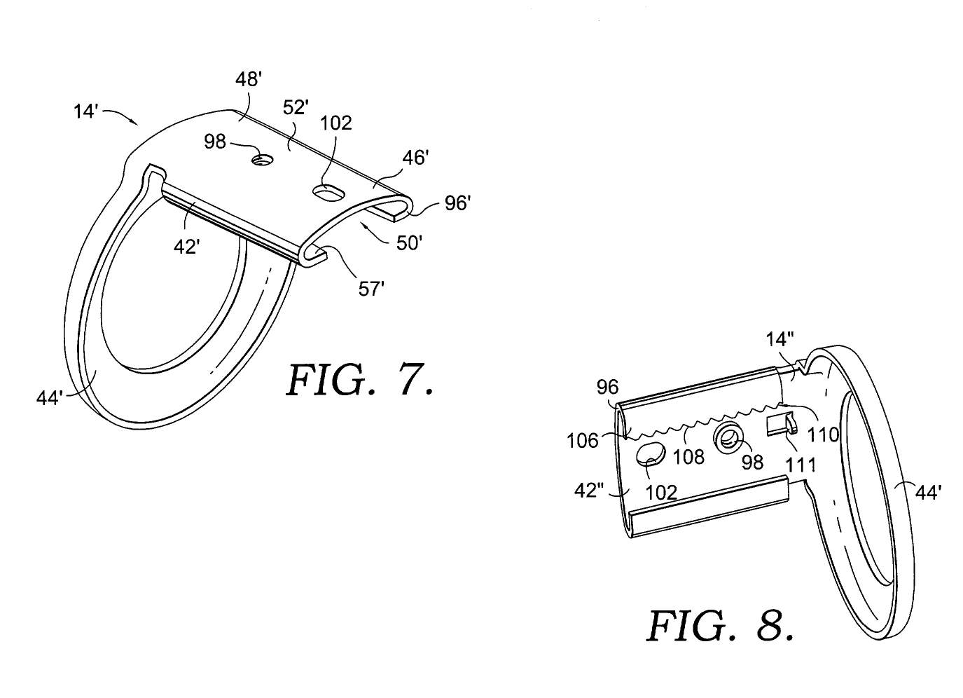

In the second embodiment, the housing 12′ includes the first mating portion 26′, as best seen in FIG. 6, which is again a longitudinal flange or rail 28′. In the second embodiment, the rail 28′ is generally a single large T-shaped flange member. The depth guide 14′ is, although not necessary, preferably formed from a single piece of metal or other material. The column 42′, as best seen in FIG. 7, preferably has a generally C-shaped cross-section which corresponds to receive the generally T-shaped rail 28′ of the housing 12′.

In the second embodiment, the outer surface 52′ of the column 42′ is devoid of the flange 76 of the column 42 of the first embodiment. The column 42′ includes a bore 98 to receive a lower end of the bolt 86′. The bolt 86′ preferably includes an annular rib 100 adjacent its lower end to prevent the bolt 86′ from being removed from cooperation with the handle portion 16′. The threaded portion of the bolt 86′ is in turn provided below the annular rib 100.

The column 42′ preferably also includes a second bore 102. An alignment pin 104 protrudes from the inner surface 70′ of the handle portion 16′. When the column 42′ of the depth guide 14′ is received in the notch 90′ of the handle portion 16′, alignment of the bolt 86′ with the bore 98 is achieved when the alignment pin 104 is received in the second bore 102. The pin 104 in the second bore 102 and the bolt 86′ in the bore 98 cooperate to couple the handle portion 16′ with the depth guide 14′ and to prevent twisting of the handle portion 16′ with respect to the depth guide 14′ during use. The cooperation of the upper surface 94′ of the notch 90′ with the upper surface 96′ of the column 42′ also works to prevent rotation of the handle portion 16 with respect to the depth guide 14 during use.

In this embodiment, when the depth guide 14′ is received on the housing 12′, a portion of the column 42′ is located between the washer 38′ and the rail 28′. Accordingly, when a user of the rotary saw tightens the locking bolt 36′, a portion of the column 42′ is pinched between the washer 38′ and the rail 28′, thereby fixing the depth of cut.

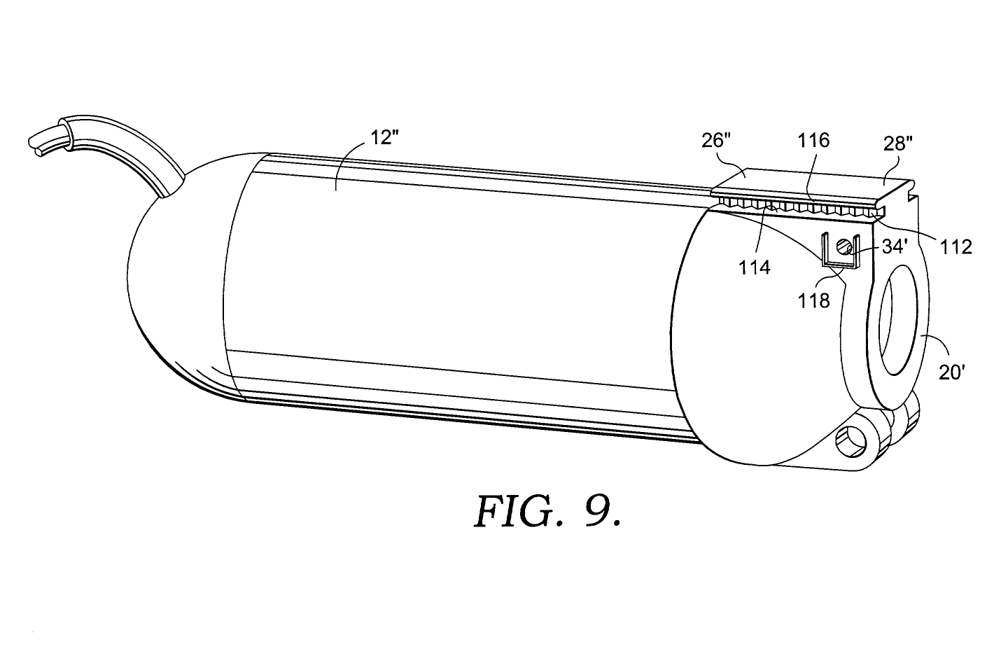

FIGS. 8 and 9 illustrate a third embodiment of the present invention, which is generally another version of the second embodiment. The elements of the third embodiment will be referenced by the numerals given above for like elements. Those elements which are modified in the third embodiment will be identified by double prime marks after the reference numeral.

As best seen in FIG. 8, a lip 106 of the column 42″ of the depth guide 14″ includes a plurality of notches 108 along an inner edge 110. The notches 108 are generally V-shaped and are preferably symmetrical and evenly spaced along the edge 110 of the lip 106. The column 42″ also includes an inwardly projecting tab 111. The tab 111 limits the distance the depth guide 14″ can be received on the housing 12″ and sets the greatest possible depth of cut permitted by the depth guide 14″. In use, as the depth of cut is increased and the guide base 44′ is moved closer to the bottom 20″ of the housing 12″, the tab 111 will eventually abut the bottom 20″ of the housing 12″ and prevent the bottom 20″ of the housing 12″ from extending below the guide base 44′. Should the locking bolt 36′ work loose during use of the rotary saw, the tab 111 will prevent the depth guide 14″ from becoming fully received on the housing 12″ and the collet from coming in contact with the workpiece.

FIG. 9 illustrates a housing 12″ of the third embodiment. The first mating portion 26″ includes a plurality of teeth 112 in a groove 114 running along a side 116 of the generally T-shaped rail 28″. The teeth 112 are generally upside down V-shaped and are preferably symmetrical and evenly spaced along the groove 114 of the rail 28″. The teeth 112 are also preferably sized to permit mating engagement with the notches 108 of the column 42″ when the depth guide 14″ is received on the housing 12″ and the lip 106 is slidingly received in the groove 114.

In use, a user adjusts the depth of cut in the third embodiment in the same manner as provided in the second embodiment (i.e. adjusting the locking bolt 36′ and moving the depth guide 14′ toward and away from the housing 12′). However, in the third embodiment, when the user tightens the locking bolt 36′, the teeth 112 interlock with the notches 108. This cooperation between the teeth 112 and the notches 108 provides a more secure setting of the depth of cut than that provided in the second embodiment, where the setting of the depth of cut relies solely on the friction between the washer 38′, the column 42′ and the rail 28. As with the other embodiments, when the locking bolt 36′ is sufficiently unscrewed, the depth guide 14″ is free to slide along the housing 12″.

The housing 12″ of the third embodiment preferably also includes a washer alignment rib 118 adjacent the bore 34′. The rib 118 is shaped and sized to surround the outer edge of the washer 38′. The rib 118 cooperates with the washer 38′ to keep the washer 38′ in the proper orientation as the locking bolt 36′ is tightened and loosened.

From the foregoing it will be seen that this invention is one well adapted to attain all ends and objects hereinabove set forth together with the other advantages which are obvious and which are inherent to the structure. It will be understood that certain features and subcombinations are of utility and may be employed without reference to other features and subcombinations. This is contemplated by and is within the scope of the invention.

Since many possible embodiments may be made of the invention without departing from the scope thereof, it is to be understood that all matter herein set forth or shown in the accompanying drawings is to be interpreted as illustrative of applications of the principles of this invention, and not in a limiting sense.

What is claimed is:

1. A rotary saw comprising:
a housing having an outer surface, a top and a bottom, wherein the housing defines an internal cavity, and wherein the housing further includes a first mating portion on the outer surface of the housing adjacent the bottom of the housing;
a motor at least partially contained in the cavity of the housing for providing rotational output for the rotary saw;
an adjustable depth guide coupled with the housing, wherein the depth guide includes a column and a guide base, wherein the column has an upper portion, a lower portion, an inner surface, an outer surface and a second mating portion, wherein the guide base is coupled with the lower portion of the column and is in a spaced relationship with the bottom of the housing, wherein the second mating portion is on the inner surface of the column and is slidably coupled with the first mating portion of the housing, whereby the column is slidably movable with respect to the housing, and whereby a user of the rotary saw can selectively move the guide base toward and away from the bottom of the housing; and
a bolt coupled with the housing, wherein the bolt cooperates with the housing to selectively prevent movement of the column with respect to the housing.

2. The rotary saw of claim 1, wherein the first mating portion on the housing includes an outwardly projecting flange, wherein the second mating portion on the column includes a channel, and wherein the flange is slidably received in the channel to facilitate the coupling of the depth guide to the housing.

3. The rotary saw of claim 2, further comprising:
a handle portion coupled with the depth guide for gripping during operation of the rotary saw.

4. The rotary saw of claim 3, wherein the column further includes a third mating portion, wherein the third mating portion is on the outer surface of the column, wherein the handle portion has an inner surface, a lower surface and a fourth mating portion, and wherein the fourth mating portion is on the inner surface of the handle portion and is coupled with the third mating portion of the housing to facilitate the coupling of the handle portion to the depth guide.

5. The rotary saw of claim 4, wherein the third mating portion on the column includes an outwardly projecting flange, wherein the fourth mating portion on the handle portion includes a channel, and wherein the handle portion is coupled to the depth guide by the flange on the column being slidably received in the channel on the handle portion.

6. The rotary saw of claim 5, wherein the handle portion further includes a second bolt and wherein the second bolt cooperates with the column to selectively prevent movement of the handle portion with respect to the column.

7. The rotary saw of claim 3, wherein the handle portion has an inner surface, a lower surface and a notch, wherein the notch is in the inner surface of the handle portion adjacent its lower surface, and wherein a portion of the column is received in the notch of the handle portion.

8. The rotary saw of claim 7, wherein the handle portion further includes a second bolt, wherein the column further includes an internally threaded bore for threadably receiving the second bolt of the handle portion to facilitate coupling the handle portion to the depth guide, wherein the notch in the handle portion has an upper surface, wherein the column has an upper surface, and wherein the second bolt in the handle portion is aligned with the bore in the column and ready for receipt therein when the column is received in the notch of the handle portion such that upper surface of the column abuts the upper surface of the notch.

9. The rotary saw of claim 1, further comprising:
a handle portion coupled with the depth guide for gripping during operation of the rotary saw, the handle portion having an inner surface and a lower surface, wherein the inner surface of the handle portion faces the outer surface of the column, wherein the lower surface of the handle portion is adjacent the guide base and is in a spaced relationship therewith, and wherein a user of the rotary saw can selectively move the guide base toward and away from the bottom of the housing without altering the spaced relationship between the guide base and the lower surface of the handle.

10. The rotary saw of claim 9, wherein the first mating portion on the housing includes an outwardly projecting flange, wherein the second mating portion on the column includes a channel, and wherein the flange is slidably received in the channel to facilitate the coupling of the depth guide to the housing.

11. The rotary saw of claim 2, wherein the first mating portion on the housing further includes a second outwardly projecting flange, wherein the second mating portion on the column further includes a second channel, and wherein the second flange is slidably received in the second channel to further facilitate the coupling of the depth guide to the housing.

12. The rotary saw of claim 11, wherein the flanges are elongate with a generally L-shaped cross-section and wherein the channels are elongate with a corresponding generally L-shaped cross-section.

13. The rotary saw of claim 1, wherein the housing further includes a transverse bore adjacent the bottom of the housing and wherein the bore receives a portion of the bolt, the rotary saw further comprising:
a nut threadably received on the bolt; and
a washer received on the bolt, wherein a portion of the housing and a portion of the column are positioned between the washer and the nut, whereby tightening of the bolt and nut squeezes the portion of the housing and the portion of the column together between the washer and the nut to prevent movement between the column and the housing.

14. The rotary saw of claim 1, wherein the first mating portion on the housing includes an outwardly projecting rail having an elongate central body with a pair of opposed flanges, wherein the second mating portion on the column includes a pair of inwardly curled edges, and wherein the column is slidably received on the rail with the pair of opposed flanges received in the pair of inwardly curled edges to facilitate the coupling of the depth guide to the housing.

15. The rotary saw of claim 14, further comprising;
a handle portion coupled with the depth guide for gripping during operation of the rotary saw, the handle portion having an inner surface and a lower surface, wherein the inner surface of the handle portion faces the outer surface of the column, wherein the lower surface of the handle portion is adjacent the guide base and is in a spaced relationship therewith, and wherein a user of the rotary saw can selectively move the guide base toward and away from the bottom of the housing without altering the spaced relationship between the guide base and the lower surface of the handle.

16. The rotary saw of claim 15, wherein the column further includes an internally threaded bore, wherein the handle portion further includes a second bolt, and wherein the second bolt is threadably received in the bore in the column to facilitate coupling of the handle portion to the depth guide.

17. The rotary saw of claim 16, wherein the column further includes a second bore therein, wherein the handle portion further includes an alignment pin projecting outwardly from the inner surface of the handle portion, and wherein the pin is received in the second bore to facilitate alignment of the second bolt and the internally threaded bore and to further facilitate coupling of the handle portion to the depth guide.

18. The rotary saw of claim 14, wherein the rail has a groove therein, wherein the groove includes a plurality of teeth, wherein one of the inwardly curled edges includes a plurality of notches therein, wherein the teeth are sized for mating cooperation with the notches and wherein the teeth and notches selectively cooperate to prevent movement of the column with respect to the housing.

19. The rotary saw of claim 18, wherein the groove is intermediate a flange and the outer surface of the housing, wherein the groove has a longitudinal axis and wherein the longitudinal axis of the groove is generally parallel to the outer surface of the housing.

20. The rotary saw of claim 19, wherein the groove in the rail is a first groove, wherein the rail has a second groove therein, wherein the second groove is in a side of the rail opposite the first groove, wherein the second groove has a smooth bottom surface, wherein the other of the inwardly curled edges is smooth and wherein the other of the inwardly curled edges is received in and selectively freely movable along the second groove.

21. The rotary saw of claim 18, further comprising;
a handle portion coupled with the depth guide for gripping during operation of the rotary saw, the handle portion having an inner surface and a lower surface, wherein the inner surface of the handle portion faces the outer surface of the column, wherein the lower surface of the handle portion is adjacent the guide base and is in a spaced relationship therewith, and wherein a user of the rotary saw can selectively move the guide base toward and away from the bottom of the housing without altering the spaced relationship between the guide base and the lower surface of the handle.

22. The rotary saw of claim 21, wherein the column further includes an internally threaded bore, wherein the handle portion further includes a second bolt, and wherein the second bolt is threadably received in the bore in the column to facilitate coupling of the handle portion to the depth guide.

23. The rotary saw of claim 22, wherein the column further includes a second bore therein, wherein the handle portion further includes an alignment pin projecting outwardly from the inner surface of the handle portion, and wherein the pin is received in the second bore to facilitate alignment of the second bolt and the internally threaded bore and to further facilitate coupling of the handle portion to the depth guide.

24. A rotary saw comprising:
a housing defining an internal cavity and having a top, a bottom, an outer surface, and a flange, wherein the flange projects outwardly from the outer surface of the housing;
a motor at least partially contained in the cavity of the housing for providing rotational output for the rotary saw; and
an adjustable depth guide slidably coupled with the housing to permit a user of the rotary saw to adjust a depth the rotary saw can cut into a workpiece, wherein the depth guide includes a column and a guide base, wherein the column has a lower portion, an inner surface and a channel, wherein the channel is formed in the inner surface of the column, wherein the channel slidably receives the flange of the housing, wherein the guide base is coupled to the lower portion of the column for supporting the rotary saw on a workpiece during use and is a distance away from the bottom of the housing, and whereby a user of the rotary saw can adjust the depth the rotary saw can cut into a workpiece by adjusting the distance the distance between the guide base and the bottom of the housing.

25. The rotary saw of claim 24, further comprising:
a bolt coupled with the housing, wherein the bolt cooperates with the housing to selectively prevent movement of the column with respect to the housing.

26. The rotary saw of claim 24, further comprising:
a handle portion coupled with the depth guide for gripping during operation of the rotary saw, the handle portion having an inner surface and a lower surface, wherein the inner surface of the handle portion faces the column, wherein the lower surface of the handle portion is adjacent the guide base and is in a spaced relationship therewith, and wherein a user of the rotary saw can selectively move the guide base toward and away from the bottom of the housing without altering the spaced relationship between the guide base and the lower surface of the handle.

27. The rotary saw of claim 24, wherein the housing further includes a second outwardly projecting flange, wherein the column further includes a second channel, and wherein the second flange is slidably received in the second channel to further facilitate the coupling of the depth guide to the housing.

28. The rotary saw of claim 24, wherein the column further has an outer surface and a flange, wherein the flange on the column projects outwardly from the outer surface of the column, the rotary saw further comprising:
a handle portion coupled with the depth guide for gripping during operation of the rotary saw, wherein the handle portion further includes an inner surface with a channel formed therein, and wherein the flange on the column is received in the channel in the handle portion to facilitate coupling of the handle portion to the depth guide.

29. The rotary saw of claim 24, wherein the outwardly projecting flange of the housing is generally T-shaped, wherein the channel in the column is defined by a pair of inwardly curled edges of the column such that the column has a generally C-shaped cross-section, and wherein the column is slidably received on the housing via the flange being received in the channel.

30. The rotary saw of claim 29, wherein the flange includes a groove therein along a side, wherein the groove includes a plurality of teeth therein, wherein one of the inwardly curled edges includes a plurality of notches therein, wherein the notches are sized to receive the teeth and wherein the teeth engage the notches and help prevent movement between the column and the housing when a user selectively sets the depth of cut.

31. A rotary saw comprising:
a housing defining an internal cavity and having a top, a bottom, an outer surface, and a flange, wherein the flange projects outwardly from the outer surface of the housing;
a motor at least partially contained in the cavity of the housing for providing rotational output for the rotary saw;
a depth guide having a column and a guide base, wherein the column has a lower portion, an inner surface and a channel, wherein the channel is formed in the inner surface of the column and slidably receives the flange of the housing to facilitate sliding coupling of the depth guide to the housing, wherein the guide base is coupled to the lower portion of the column and supports the rotary saw on a workpiece during use; and
a handle portion coupled with the depth guide for gripping by a user during operation of the rotary saw, the handle portion having an inner surface and a lower surface, wherein the inner surface of the handle portion faces the column, wherein the lower surface of the handle portion is adjacent the guide base and is in a spaced relationship therewith, and wherein a user of the rotary saw can selectively move the guide base toward and away from the bottom of the housing without altering the spaced relationship between the guide base and the lower surface of the handle.

32. A rotary saw comprising:
a housing defining an internal cavity and having a top and a bottom;
a motor at least partially contained in the cavity of the housing for providing rotational output for the rotary saw;
a depth guide slidably coupled with the housing and having a column and a guide base, wherein the column has a lower portion, wherein the guide base is coupled to the lower portion of the column and supports the rotary saw on a workpiece during use, and wherein a user can adjust a cutting depth of the rotary saw by moving the guide base toward and away from the bottom of the housing; and
a handle portion coupled with the depth guide for gripping by a user during operation of the rotary saw, the handle portion having a lower surface, wherein the lower surface is adjacent the guide base and is in a spaced relationship therewith, and wherein a user can adjust the cutting depth without altering the relationship between the guide base and the lower surface of the handle portion, whereby a distance between the handle portion and a workpiece does not change when a user moves the guide base toward and away from the bottom of the housing and adjusts the cutting depth.

33. A rotary saw comprising:
a housing defining an internal cavity and having a top, a bottom and an outer surface;
a motor at least partially contained in the cavity of the housing for providing rotational output for the rotary saw;
a depth guide for adjusting a cutting depth of the rotary saw, the depth guide having a column and a guide base, wherein the guide base is coupled to the column and supports the rotary saw on a workpiece during use;
means for slidably coupling the depth guide to the housing;
means for selectively preventing movement between the depth guide and the housing;
a handle portion; and
means for coupling the handle portion to the depth guide.

34. The rotary saw of claim 33, wherein the means for slidably coupling the depth guide to the housing includes a flange projecting outwardly from the outer surface of the housing and a channel in the column of the depth guide, the flange being slidably received in the channel to facilitate the slidable coupling of the depth guide to the housing.

35. The rotary saw of claim 34, wherein the means for coupling the handle portion to the depth guide includes a flange projecting outwardly from the column and a channel in the handle portion, the flange of the column being slidably received in the channel of the handle portion to facilitate the coupling of the handle portion to the depth guide.

36. The rotary saw of claim 33, wherein the means for coupling the handle portion to the depth guide includes a flange projecting outwardly from the column and a channel in the handle portion, the flange of the column being slidably received in the channel of the handle portion to facilitate the coupling of the handle portion to the depth guide.

37. A rotary saw comprising:
a housing having a first mating portion;
a motor at least partially received in the housing;
an adjustable depth guide having a lower surface and a second mating portion, wherein the depth guide is coupled with the housing; and
a handle portion having a lower surface, wherein the handle portion is coupled with depth guide and wherein the lower surface of the handle portion is generally coplanar with the lower surface of the depth guide.

38. The rotary saw of claim 37, wherein the handle portion is coupled with the depth guide such that the lower surface of the handle portion abuts a surface of a workpiece during use.

39. A rotary saw comprising:
a housing;
a motor at least partially received in the housing; and
a handle portion coupled with the housing, wherein the handle portion includes a lower surface and wherein the handle portion is coupled with the housing such that the lower surface of the handle portion is close to a surface of a workpiece during use.

40. The rotary saw of claim 39, wherein the handle portion is coupled with the housing such that the lower surface of the handle portion abuts the surface of the workpiece during use.

41. A rotary saw comprising:
a housing having a longitudinal axis;
a motor at least partially received in the housing;
an adjustable depth guide; and
a handle portion coupled with housing, the handle portion having a gripping portion with a gripping axis, wherein the gripping axis is angled with respect to the longitudinal axis of the saw.

42. The rotary saw of claim 41, wherein the angle between the longitudinal axis and the gripping axis is acute.

43. The rotary saw of claim 42, wherein the angle is approximately 19°.
